(19) United States
(12) Patent Application Publication
(10) Pub. No.: US 2021/0079544 A1
(43) Pub. Date: Mar. 18, 2021

(54) METHOD OF CONFIGURING A WATER ELECTROLYSIS SYSTEM

(71) Applicant: SHELL OIL COMPANY, Houston, TX (US)

(72) Inventors: Jayakrishnan HARIKUMARAN, Nottingham (GB); Jeffrey Brendan MARTIN, Amsterdam (NL); Charudatta Subhash PATIL, Amsterdam (NL)

(73) Assignee: Shell Oil Company, Houston, TX (US)

(21) Appl. No.: 17/044,291

(22) PCT Filed: Feb. 28, 2019
(86) PCT No.: PCT/EP2019/054958

§ 371 Date: Sep. 30, 2020

(30) Foreign Application Priority Data
Mar. 1, 2018 (EP) 18159458.1

(51) Int. Cl. C25B 15/02; C25B 1/04; H02S 10/10; H02J 3/38

(52) U.S. Cl. CPC C25B 15/02; C25B 1/04; H02S 10/10; H02J 2300/30; H02J 2300/26; H02J 2300/28; H02J 3/381

(57) ABSTRACT

The present invention relates to a direct-coupled water electrolysis system and a method of configuring a such system comprising at least four components, a PV-array which is directly connected to one or more electrolyzer stacks, an electrolyzer system balance-of-plant, and an auxiliary power supply, the method comprising the steps of:
a) providing a predetermined initial performance curve, providing an average degradation rate, and calculating an anticipated performance curve of the PV array;
b) providing a predetermined initial performance curve, providing an average degradation rate, and calculating an anticipated performance curve of the electrolyzer stack(s);
c) configuring the electrolyzer stack(s) by matching the anticipated electrolyzer stack(s) performance curve with the anticipated PV array performance curve.

The invention provides for operating a solar photovoltaic coupled electrolyser system at large scale up to multi-GW installed capacity, with few power electronics and conversions enabling low capital costs and optimised efficiency of the system.

### FIELD OF THE INVENTION

The present invention is directed to a method of configuring a water electrolysis system and to such a system. The electrolysis system typically has a photovoltaic array for providing current and voltage output, and an electrolyser arrangement having at least one electrolyser stack directly connected to the photovoltaic array.

### BACKGROUND TO THE INVENTION

Hydrogen is a molecule of key interest for the future energy transition, either as a commercial fuel for automotive fuel cell applications, or as a carrier to move renewable energy over long distances. The viability of hydrogen manufactured from renewable power sources will depend on whether it can ever compete on a cost basis with hydrogen from fossil fuels via steam-methane reforming. Electrolysis is a promising option for hydrogen production from renewable power sources. Electrolysis is a process using electricity to split water into hydrogen and oxygen. This reaction typically takes place in a unit called an electrolyser stack, which is the electrochemical reactor contained in an electrolyser system. A conventional line-up (FIG. 1) for a solar photovoltaic array (100) coupled to an electrolyser system (120) would include a single power connection, with an alternating current (AC) interface (110). The photovoltaic array generates direct current (DC) power which would be converted to AC via inverters (105), stepped up to a higher voltage for transfer to another part of the plant, the voltage stepped down and the AC power used to supply to the electrolyser system (120). The AC power connection provides 100% of the required electrolyser system power. An electrolyser stack (125) utilizes direct current (DC) power to drive the electrochemical splitting of water to make hydrogen, and constitutes a significant amount of the total power demand. Electrolyser systems include power electronics (130), and also a recitifier (135) to convert AC power to DC power. The electrolyser also contains additional hardware required to support the operation of the electrolyser stack (125), commonly referred to as the balance of plant, BoP (140).

As solar photovoltaic and water electrolyser stacks are both DC electrical systems, a possible route to reduce system costs is the coupling of these devices such that the AC conversion is obviated (DC-DC conversion). In more extreme cases it may be possible to remove the power conversions completely, or almost completely, here the solar photovoltaic array and electrolyser stacks are direct coupled. Some prior art documents describe such methods.

Patent application WO07142693A2 describes an array of photovoltaic (PV) module(s) arranged in series and/or in parallel to deliver direct current electrical power to an electrolyser to produce hydrogen. The system includes power electronics and switching, to modify the configuration or selection of the photovoltaic array to deliver at its maximum power point (Vₘₚₚ and Iₘₚₚ) and provide Vₒₚₑᵣ at Iₒₚₑᵣ at the electrolyser.

Patent application CN101565832A relates to a solar coupled electrolysis system containing an electrolysis stack which is subdivided into modules of electrolysis cells. Power electronics and switching are employed to direct power to different modules of electrolysis cells depending on the amount of power available from the photovoltaic array.

Patent application US02033332 describes a water electrolytic system comprising of photovoltaics, a water electrolyser and power electronics for DC/DC conversion to extract the maximum power from the photovoltaic cells.

The above described references in solar photovoltaic coupled water electrolysers use a control system for monitoring system performance or environmental conditions and optimizing the system. This may add significant cost for hydrogen production due to the capital cost associated with additional power conversion and control hardware.

Another patent application US2005189234 discloses a method for configuring a solar hydrogen generation system. The method claims optimization of the water electrolysis system by matching the most efficient voltage generated by photovoltaic cells to the most efficient input voltage required by a single electrolysis cell (required voltage 1-3V). US2005189234 covers a direct coupled photovoltaic cell(s) directly coupled to a single electrolyser cell, therefore covering a small-scale application range which would not be economical to implement at larger scales of required hydrogen output.

Patent application US070277870 describes a solar energy device consisting of photovoltaic cells and batteries connected in parallel to power an electrolyser. This reference is specified based on the presence of a parallel coupled battery array, which increases the cost of the overall system.

Patent application WO2018033886 describes a concept of matching the power curves of photovoltaic cells and an electrolysis cell. This application specifically covers an integrated photoelectrochemical device where the photovoltaic cell and electrolyser electrode are connected, in fact directly bonded, by a solid interface.

Although there are already some publications about the option of direct coupling methods for coupling of a PV array and an electrolyser to produce hydrogen, there is still a need for more efficient direct coupling methods, that are particularly suited for the development of large scale hydrogen production systems.

### SUMMARY OF THE INVENTION

Accordingly, the present invention relates a more efficient direct coupling method, in particular to a method of configuring a direct-coupled water electrolysis system comprising at least four components, wherein the first component is a PV-array which is directly connected to the second component which is an electrolyzer stack or multiple electrolyzer stacks, the third component is an electrolyzer system balance-of-plant (BoP), and the fourth component is an auxiliary power supply, the method comprising the steps of:

a) providing a predetermined initial performance curve of the PV array;

b) providing an average degradation rate of the PV array;

c) calculating an anticipated performance curve of the PV array for a specific timeline by modifying the predetermined initial performance curve based on the average degradation rate;

d) providing a predetermined initial performance curve of the electrolyzer stack or multiple electrolyzer stacks;

e) providing an average degradation rate of the electrolyzer stack or multiple electrolyzer stacks;

f) calculating an anticipated performance curve of the electrolyzer stack or multiple electrolyzer stacks for a specific timeline by modifying the predetermined initial performance curve based on the average degradation rate for each individual stack;

g) configuring the electrolyzer stack or multiple electrolyzer stacks by matching the anticipated electrolyzer stack or multiple electrolyzer stacks performance curve with the anticipated PV array performance curve.

The present invention further relates to a water electrolysis system comprising at least four components, wherein

(1) the first component is a PV-array which is directly connected to
(2) the second component which is an electrolyzer stack or multiple electrolyzer stacks, so that there are no power conversion steps present in the direct coupled connection;
(3) the third component is an electrolyzer system balance-of-plant, comprising supporting hardware required for efficient operation of the electrolyser stack, computer control systems, safety systems and power supply, and
(4) the fourth component is an auxiliary power supply for the stable and safe operation of the third component.

The method and system of this invention provide for operating a fully operational solar photovoltaic coupled electrolyser system, at a scale of 10's of kW to multi-GW installed capacity, with the lowest possible content of power electronics and conversions to enable the lowest possible capital costs and optimised efficiency of the system.

### BRIEF DESCRIPTION OF THE DRAWINGS

The figures depict one or more implementation options in accordance with the present disclosure, by way of example only, not by way of limitation.

FIG. 1 is an example of a traditional connection of a solar photovoltaic array to an electrolyser system (comparative example);

FIG. 2 is an exemplary diagram of an embodiment of the solar photovoltaic direct coupled electrolyser system of this disclosure;

FIG. 3 is a diagram showing examples of I-V curves of a photovoltaic module;

FIG. 4 is an example of a P-V curve of the photovoltaic module;

FIG. 5 is an example of a I-V curve (commonly called a polarization curve) of the electrolyser arrangement;

FIG. 6 is an exemplary diagram indicating matching the P-V curve of the photovoltaic array with the polarization curve of the electrolyser arrangement in accordance with an embodiment of the invention;

FIG. 7 is an exemplary diagram showing an example of matching of the I-V curve of the photovoltaic array with the polarization curve of the electrolyser arrangement in accordance with an embodiment of the invention;

FIG. 8 is an exemplary schematic of a very large scale solar photovoltaic direct coupled electrolyser system, showing repeat units of distributed single electrolysers with direct coupled photovoltaic arrays;

FIG. 9 is an example schematic of a very large scale solar photovoltaic direct coupled electrolyser system, showing a centralized electrolysis location. Direct coupled power connections bring power to the centralized electrolyser systems;

FIG. 10 is an exemplary diagram showing an example of drift in the electrolyser polarization curve with aging according to an embodiment of the invention;

FIG. 11 is a diagram showing an example of drift in the photovoltaic I-V curve with aging according to an embodiment of the invention.

### DETAILED DESCRIPTION OF THE INVENTION

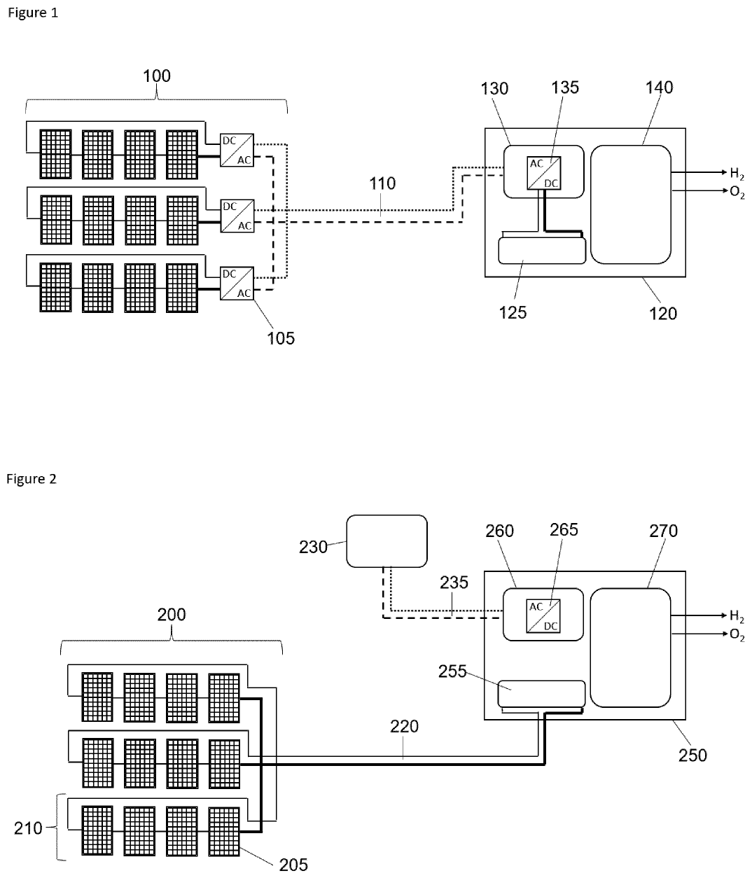

The conventional line-up for a large scale solar photovoltaic coupled water electrolyser system would include a single power connection, with an alternating current (AC) interface (FIG. 1, 110). The photovoltaic power would be converted to AC via inverters (105), stepped up to a higher voltage for transfer to another part of the plant, the voltage stepped down and the AC power used to supply to the electrolyser system. The AC power connection (110) provides 100% of the required electrolyser system (120) power. An electrolyser stack (125) utilizes direct current (DC) power to drive the electrochemical splitting of water to make hydrogen, and constitutes a significant amount of the total power demand. Electrolyser systems (120) include power electronics (130) which also incorporates a recitifier (135) to convert AC power to DC power.

As solar photovoltaic and water electrolysers are both DC electrical systems, a possible route to reduce system costs is the coupling of these devices such that the AC conversion is obviated (DC-DC conversion via power electronics). The present disclosure relates to a system wherein the power electronics are almost completely removed, and the solar photovoltaic array is direct coupled to the electrolyser stack as shown in FIG. 2.

The present disclosure provides a method of configuring a large scale solar photovoltaic coupled water electrolyser system having at least four components. One of the components is typically a solar photovoltaic array (200, see FIG. 2) for providing current and voltage output and one component is typically an electrolyser arrangement, having at least one electrolyser stack (255), directly connected to the solar photovoltaic array, without any power conversion steps present (220). Additionally, the water electrolysis system (250) contains a third component, typically referred to as the electrolyser balance of plant (BoP, 270) which contains all supporting hardware required for efficient operation of the electrolyser stack, including such items as electrolyte circulation, heat exchangers, gas/liquid separators, gas processing, gas quality analysis, computer control systems, safety systems and power supply. The fourth component is an auxiliary power supply (230) which is required for the stable and safe operation of the BoP, which typically would include an AC electrical connection (235). The auxiliary power supply may consist of any combination of an electrical grid connection, solar photovoltaics, wind power, batteries, fuel cells, hydroelectric power or any other electrical power source.

According to the present disclosure the solar photovoltaic array is directly connected to the electrolyser stack, with no power conversion steps present. The method of matching comprising the steps of providing a predetermined performance curve of the solar photovoltaic modules (205); providing a degradation rate of the photovoltaic modules; calculating an anticipated performance curve of the photovoltaic modules for a specific timeline by modifying the predetermined performance curve of the photovoltaic modules based on the degradation rate of the photovoltaic modules; optimizing the configuration of the electrolyser stack(s) to match its performance curve with the anticipated performance curve of the photovoltaic modules. In particular, the specific timeline considered for calculating the anticipated performance curves in step c) and f), respectively, is any time between the start of life and end of life of the PV array and any time between the start of life and end of life of the electrolyzer stack or multiple electrolyzer stacks, respectively. In one embodiment the auxiliary power supply may be an electrical grid connection, to provide power to the electrolyser system balance of plant. In a preferred embodiment, the auxiliary power supply is configured to provide a stable power supply to the electrolyzer balance-of-plant for some required duration. The required duration is determined by the safety, start-up and shut-down characteristics of the electrolyser system. The duration may be for some defined number of hours, for example 4 hrs or 24 hrs supply to the electrolyser balance of plant, or may alternatively be specified to provide constant power. The power source of the auxiliary power supply may be selected from one or more of the following: electrical grid, solar photovoltaics, wind, batteries, fuel cells, pumped hydro electric and wave generated renewable power. A preferred power source is selected from one or more renewable power sources. In particular, the power source of the auxiliary power supply is selected from one or more of the following: wind turbines, PV arrays, fuel cells with fuel storage or battery storage.

A directly coupled system according to the present disclosure as shown in FIG. 2 typically comprises a photovoltaic array which is directly connected to an electrolyser arrangement, having at least one electrolyser stack, via a DC electrical connection. The DC electrical connection may consist of standard electrical components such as cables or busbars. There are no power conversion steps present in the direct coupled DC electrical connection. The electrolyser system (250) consists of the electrolyser stack (255), and additionally all supporting hardware required for efficient operation of the electrolyser stack, including such items as electrolyte circulation, heat exchangers, gas/liquid separators, gas processing, gas quality analysis, computer control systems, safety systems and power supply (collectively referred to as the balance of plant, BoP, 270). A second auxiliary power supply (230) is required for the stable and safe operation of the BoP, which typically would include an AC electrical connection (235). The electrolyser system will contain power electronics (260) which may be considerably smaller than in a conventional lineup (see for example FIG. 1). The power electronics (260) may optionally contain a rectifier (265), depending on the requirements of the BoP but not to provide power to the electrolyser stack (255).

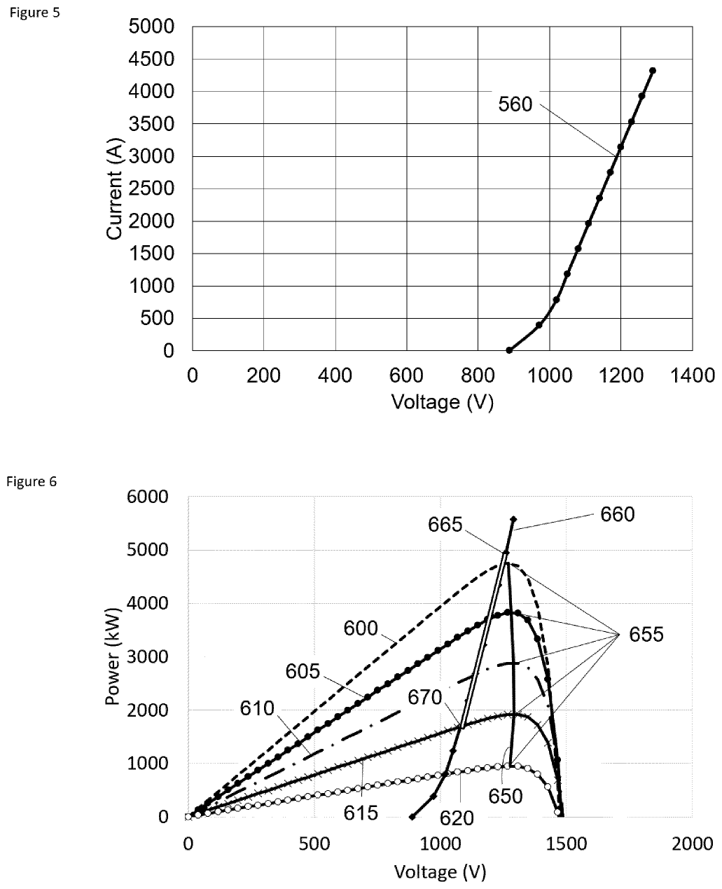

In a directly coupled system as shown in FIG. 2 the electrolyser stacks(s) have a defined relationship between voltage and current, commonly referred to as a polarization or I-V curve (FIG. 5). The performance of the electrolyser stack may also include an expected degradation rate, typically in μV/hr which defines the increase in operating voltage, at a specified operating current, due to degradation. FIG. 10 shows an example of aging of the electrolyser system with increasing operating hours (vide infra).

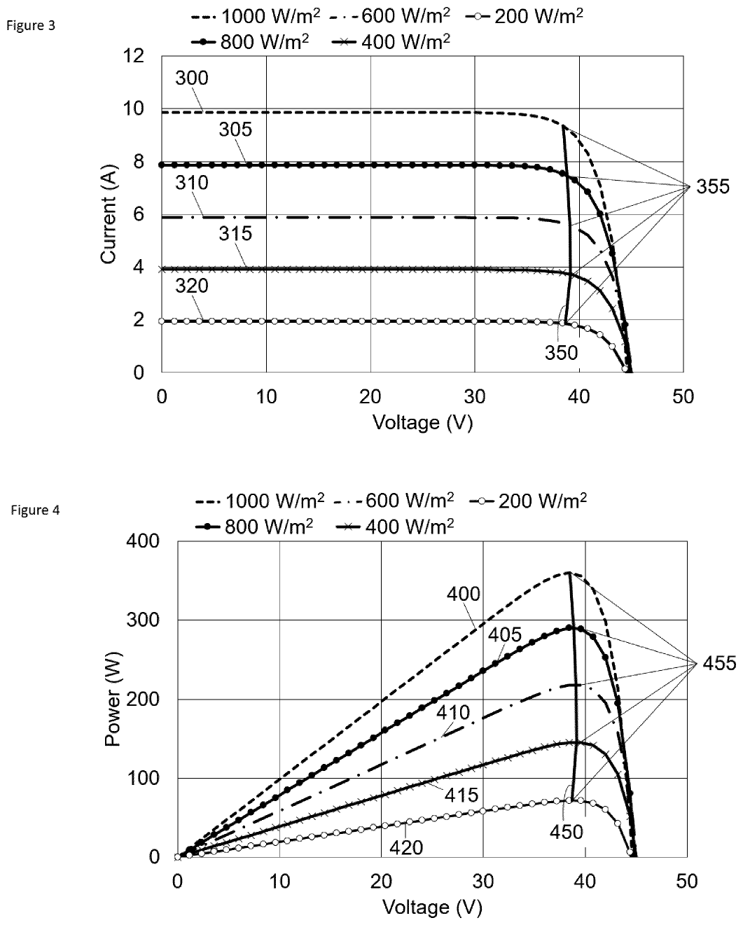

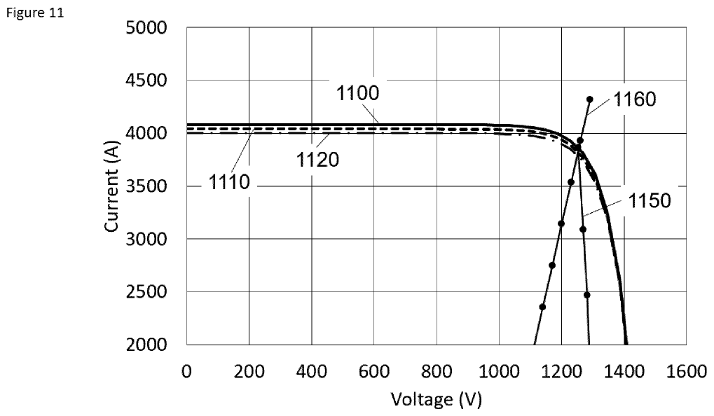

The solar photovoltaic array consists of modules, which may include any number of solar photovoltaic cells. A solar photovoltaic module has a defined relationship between current and voltage, which defines the range of output as a function of various parameters such as incident solar irradiance and temperature (FIG. 3). The output (performance curve) of a photovoltaic array (FIG. 2, 200) can be calculated by multiplying the voltage provided by a single module (205) by the number of modules in the string (210). The total photovoltaic array current is determined by choosing the total number of parallel strings (210) and multiplying. The performance of the photovoltaic module may also include an expected degradation rate, typically loss of power output as % per year due to degradation. FIG. 11 shows an example of the degradation in current of a photovoltaic array with increasing operating hours (vide infra).

The active material of the solar photovoltaic modules may preferably be selected from: silicon, perovskites, III-V (for example GaAs based) or organic based. The number of photovoltaic cells per module may vary depending on the technology chosen and the module configuration, with common examples being 60 cell, 72 cell, 120 cell (2×60) or 144 cells (2×72). The semiconductor technology may be single or multi-junction cells, of monofacial or bifacial design. The installation of the modules may be fixed, or include tracking to maximise the incident solar irradiation.

The technology of the electrolyser stack is preferably selected from: acidic polymer electrolyte (PEM) based, anionic polymer electrolyte (AEM) based, alkaline electrolysis with a diaphragm cell separator or high temperature systems with ceramic based electrolytes (solid oxide electrolyser, SOEC). An electrolysis stack contains a number of electrolysis cells, which are internally connected in series in a so-called bipolar stack arrangement. The number of cells in the stack will vary by technology and may be expected to fall in the range of 20 to 1000 cells. The individual cell voltage may be expected to be in the range 1.7-2.5V for an alkaline electrolyser, for example. Therefore the individual electrolysis stack voltage would be expected to be from approximately 35V to in excess of 1500V.

The balance of plant (BoP) of the electrolyser system is optimized based on the size of the electrolyser stack(s), the technology of the electrolyser stack and other considerations such as safety requirements and product quality specifications. The safe and stable operation of the BoP requires a stable auxiliary power supply. The auxiliary power supply may include any number of power sources, designed to guarantee a defined minimum level of power availability. Some specific examples may be a connection to the electrical grid, with a battery for unexpected loss of grid power. Other alternatives could be a second photovoltaic array, with batteries, to provide power to the BoP. The power rating of the auxiliary power supply is significantly lower than the direct coupled solar photovoltaic array, for example in one design the power rating of the auxiliary power supply may be 10-20% of the total system power, with 80-90% of the total system power being provided by the direct coupled solar photovoltaic array. In such a system, the size of the electrolyser stack(s) may be expected to be in the range 10 kW to 10 MW per single stack, in correlation, the size of the direct coupled solar photovoltaic array may be configured to provide power from 10 kW to more than 10 MW.

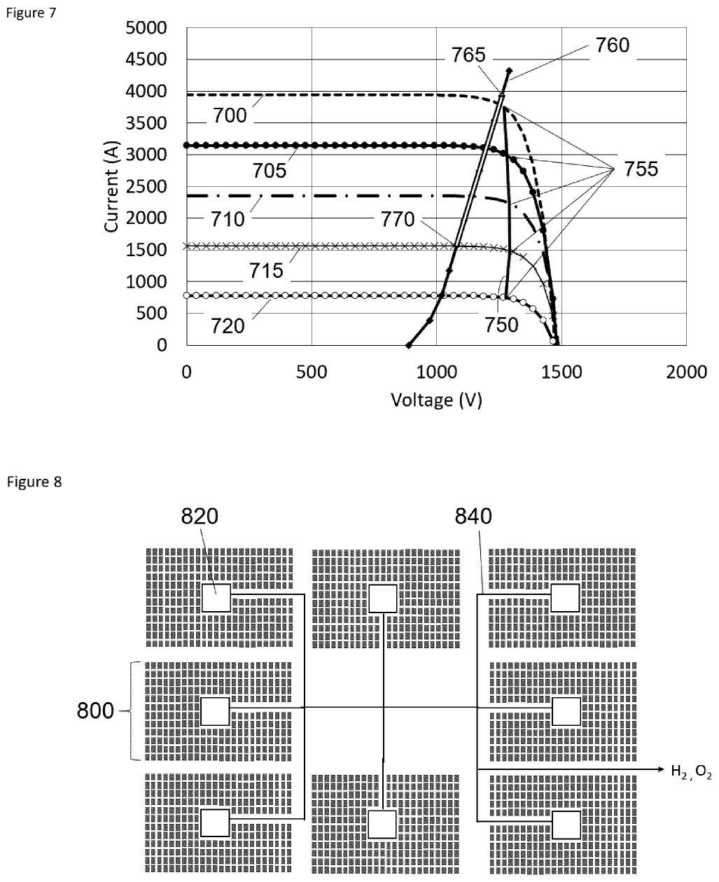

In a directly coupled system as described in FIG. 2, the power characteristics of the solar photovoltaic array may be carefully optimized such that the total power output characteristics carefully matches the requirements of the electrolyser stacks(s) (FIG. 6 and FIG. 7). The system is configured by matching a predefined performance curve of the photovoltaic array with a predefined performance curve of the electrolyser arrangement. The system configuration includes deciding the configuration of the photovoltaic array for a specific configuration of an electrolyser arrangement or deciding the configuration of the electrolyser arrangement for a specific configuration of a photovoltaic array.

Photovoltaic module vendors usually provide technical data including performance curves: I-V and P-V curves for the modules. A P-V curve describes the power-voltage correlation at different solar irradiance levels and an I-V curve describes the current-voltage correlation at different solar irradiance levels for a certain type of photovoltaic module. For an example of the single photovoltaic module characteristics refer to FIG. 3 for I-V curves and FIG. 4 for P-V curves. These one or more performance curves calculated for the photovoltaic array are referred to as the one or more predetermined performance curves of the photovoltaic array.

An electrolyser vendor may provide data for an electrolyser cell or stack and these data can be used for deriving polarization curves for the cell or stack. A polarization curve (I-V curve) of an electrolyser cell or stack is the relationship between cell/stack potential (V) and applied current (I) and is the most basic and characteristic representation of the performance of a single cell or electrolyser stack. If the cell polarisation curve is available, the stack polarisation curve may be obtained by multiplying the cell voltage range by the total number of cells in a series bipolar arrangement. Once a polarization curve is derived for an electrolyser stack or cell, a power-voltage (P-V) relation can be further derived from the polarization curve data. The two curves (i.e. P-V curve and I-V curve) derived for the electrolyser arrangement are referred to as predetermined performance curves of the electrolyser arrangement. FIG. 5 represents an example of a predetermined I-V performance curve of an electrolyser arrangement.

A solar photovoltaic module will have a defined relationship between current and voltage, commonly referred to as a I-V curve (FIG. 3). The relationship of V and I at different incident irradiance levels is shown by curves (300) to (320), for irradiances of between 200 and 1000 W/m². A certain combination of V and I results in the maximum power available from the PV module, shown as the points (355) on the chart. The line of maximum power points, or MPP line (350), shows the maximum power conditions for all irradiances for the module.

In one embodiment of the invention, aging of the solar photovoltaic array has been considered for configuring the matching of the electrolyser stack components. Power curves provided by the manufacturer will be applicable only from the start of life performance of a solar photovoltaic module and array of modules. The performance of the solar photovoltaic modules and array may degrade, as the modules and array operate over time. This degradation manifests as a reduction in current output with time for a given voltage of the photovoltaic module. Typically, solar photovoltaic module vendors will quote degradation figures expressed as a percentage loss of power output for a period (may be in years) and based on this data an annual degradation rate of the photovoltaic array can be derived. By using this annual degradation rate of power, an anticipated performance curve of the photovoltaic array can be calculated for any timeline starting from the start of life of the array.

In one embodiment, the anticipated performance curve is calculated by considering the end of life performance of the photovoltaic array. In another embodiment, the anticipated performance curve is calculated by considering the midlife performance of the photovoltaic array.

FIG. 11 shows an example of an aging trend of the photovoltaic array with an exemplary degradation rate of “D” defined in power degradation percentage per year since first use of the electrolyser arrangement plotted for a period of 0 to N years of age of the photovoltaic array. First performance curve (1100) represents the start of age performance curve of the photovoltaic array at a particular solar irradiance that may be selected based on the maximum irradiance at a particular location where the electrolyser system is planned to be installed. First and second anticipated performance curve, (1110) and (1120), represent examples of deteriorating performance curves of the photovoltaic array at different, progressing times. For calculating the anticipated performance curves (1110) and (1120) of the photovoltaic array, current values (I) may be modified by subtracting the anticipated degradation at a specific timeline from the predetermined performance curve (1100).

If “N” is the age of the photovoltaic array in years at a specific timeline and “D” is the annual power degradation rate in percentage per year, then the anticipated current values (I^{N}) at a specific timeline (specific age N) may be calculated by using the formula:

I^{N}=I−(I*N*D/100) (1)

wherein I is the current value at a specific voltage as per the predetermined performance curve (1100) of the photovoltaic array as shown in FIG. 11. It indicates the start of life performance of the photovoltaic array.

In one embodiment of the invention, the annual degradation rate D is calculated based on the manufacturer supplied data.

If a manufacturer quotes a degradation of R percentage loss of power output in Nₘₐₓ years, then D may be calculated by using a relation:

D=R/Nₘₐₓ (2)

For calculating the anticipated performance of P-V curves, power values (P) may be modified by subtracting the anticipated degradation at a specific timeline. If “N” is the age of the photovoltaic array in years at a specific timeline and “D” is the annual power degradation rate in percentage per Year, then the anticipated current values (P^{N}) at a specific timeline (specific age N) may be calculated by using the formula:

P^{N}=P−(P*N*D/100) (3)

wherein P is the power value at a specific voltage as per the conventional P-V curve of the photovoltaic array as shown in FIG. 4 and it indicates the start of life performance of the photovoltaic array.

In one embodiment of the invention, the annual degradation rate D is calculated based on the manufacturer supplied data.

If a manufacturer quotes a degradation of R percentage loss of power output in Nₘₐₓ years, then D may be calculated by using the relation:

D=R/Nₘₐₓ (4)

In one embodiment of the invention, aging of the electrolyser stack arrangement has been considered for configuring the electrolyser system components.

FIG. 10 shows an example of an aging trend of an electrolyser stack with an exemplary degradation rate of “d” defined in voltage per operation hours of the electrolyser arrangement plotted for a period of 0 to Tₙ hours of operation of the electrolyser arrangement. The characteristic curve (1000) of the electrolyser arrangement at the start of operation (0 hours) of the electrolyser arrangement is shown. The anticipated performance curves (1005), (1010), (1015) and (1020) indicate the performance curve of the electrolyser arrangement at progressing times (Tₙ operation hours). The curves (1005), (1010), (1015) represent the anticipatory performance curve of the electrolyser arrangement at timelines between 0 hours of operation and Tₙ hours of operation of the electrolyser arrangement. Operating window (1030), i.e. a subsection of the performance curve (1000), represents the operating window of the electrolyser arrangement at the starting stage (0 hours). As the anticipatory performance curves (1005) and (1010) move to higher voltages, due to degradation, the operating window accordingly moves to higher voltages (1045). Portion (1050) of the anticipated performance curve (1020) represents the operating window of the electrolyser arrangement at Tₙ operation hours.

The anticipated performance curves (1005) to (1020) of the electrolyser arrangement may be calculated by increasing the voltage values at specific currents based on the degradation rate of the electrolyser arrangement. For calculating the anticipated performance of the electrolyser arrangement, voltage values (V) may be modified by applying the degradation rate for some defined number of operating hours. Herein, “Tₙ” may indicate the operation hours of the electrolyser arrangement at a specific timeline and “d” is the degradation rate of the electrolyser arrangement expressed as voltage per operation hour. Then the anticipated voltage values (Vⁿ) at a specific timeline (Tₙ operation hours) may be calculated using the formula:

Vⁿ=V+(V*Tₙ*d) (5)

wherein V is the voltage value at a specific current as per the start of life performance curve (560) of the electrolyser arrangement as described in FIG. 5. This indicates the start of life performance of the electrolyser arrangement.

Lower operating point (1035) of the electrolyser arrangement is defined by minimum operating current (1060) of the electrolyser arrangement. Cut-in power requirement increases with aging as indicated by the higher voltage (1075) at the same operating current (1060) at Tₙ operating hours of the electrolyser arrangement.

Maximum operating point (1040) of the electrolyser arrangement may be defined by the maximum operating current of the electrolyser arrangement, which is defined in relation to the maximum amount of hydrogen to be produced. There is also a maximum allowable voltage (1080) to protect the stack. Therefore the maximum power increases with aging as indicated by the maximum operating voltage (1080) at Tₙ operating hours of the electrolyser arrangement. In this region, the required power increases, at constant maximum hydrogen production. At even larger Tₙ operating hours, the operating window contracts due to the movement of the performance curve (1015, 1020) and the maximum operating voltage (1080). In this region the hydrogen production potential shall be decreased, so as to not exceed the maximum allowable voltage and protect the stack.

The lower operating point (1035) and maximum operating point (1040) define the operating window (1030) of the electrolyser arrangement. With time, said operating window moves to higher voltages, from operating window (1030) at start of life to operating window (1045) of curve (1010) at some operating hours, Tₙ. At even higher operating hours, the operating window (1045) contracts down to operating window (1050) of curve (1020).

The result of higher voltages, reduced operating window and lower currents has a relatively complex relationship with power utilization and hydrogen production potential, and depends on the matching strategy employed. Actual power utilization level and hydrogen production potential are maximized by opting for lower voltage arrays and maximizing current. When considering aging, if the maximum current of the electrolyser arrangement reduces faster than the maximum photovoltaic array current, there could be issues. For instance, the electrolyser stack may receive too much power, if the electrolyser system components were matched on start of life performance. It is important to note, therefore, that the systems may need to be matched based on anticipated end of life performance.

In an embodiment of the invention, aging of both the electrolyser arrangement and the photovoltaic array is considered for matching the performance curves. When aging of both the photovoltaic array and electrolyser arrangement are considered together, the total available power from the photovoltaic array decreases and the total amount of power used in the direct coupling case may be quite stable. The hydrogen production decreases as the system ages, but the relative amount of hydrogen production in the direct coupled solar water electrolysis system may be more stable, compared to a typical conventional solar electrolysis system wherein power electronics are involved between the solar cells and the electrolyser.

In one embodiment of the invention, the electrolyser arrangement is defined first based on the desired total power or hydrogen production requirement, paying attention to practical limitations on the DC electrical connection. A next step is to match the photovoltaic array to the electrolysis requirements by selecting the number of modules in series in a string (voltage) and the number of parallel strings (current). The maximum irradiance line should have been set to be equal to the maximum real irradiance at a chosen location. Therefore the performance curve of the photovoltaic array at maximum real irradiance at a respective location can be matched close to the maximum operating point of the electrolyser arrangement. Close herein being, for instance, in the range of +/−2.5%. The maximum photovoltaic output at high irradiance should not normally exceed the electrolyser line, therefore protecting against over-power.

FIG. 6 represents a method of matching of the P-V curve of the photovoltaic array with a characteristic curve of the electrolyser arrangement. P-V curves (600), (605), (610), (615), (620) represent the P-V curves of the photovoltaic array at different solar radiation intensities. FIG. 6 also shows max power curve (650) representing a plot of maximum power points (655) of the P-V curves of the solar photovoltaic array. Maximum power curve (650) may also be referred to as MPP curve. The characteristic curve (660) of the electrolyser arrangement is also indicated, also showing the maximum operating point (665) and the minimum continuous operating point (670). In one embodiment of the invention, the P-V curves (600), (605), (610), (615), (620) represent the anticipated performance curve of the photovoltaic array at respective times (N). In one embodiment of the invention, electrolyser performance line (660) represents the anticipated performance curve of the electrolyser arrangement at a specific timeline (Tₙ operation hours).

FIG. 7 represents a method of matching the I-V curve of the photovoltaic array with a characteristic curve of the electrolyser arrangement. I-V curves (700), (705), (710), (715), (720) represent the I-V curves of the photovoltaic array at different solar radiation intensities. FIG. 7 also indicates max power curve (750) representing a plot of maximum power points (MPP curve, 755) of the I-V curves of the solar photovoltaic array. Max power curve (750) may also be referred to as. In an embodiment of the invention, anticipated performance curves (700), (705), (710), (715), (720) represent the anticipated performance curve of the photovoltaic array at respective times on a specific timeline (N). In an embodiment of the invention, the characteristic curve (760) represents the anticipated performance curve of the electrolyser arrangement at a specific timeline (Tₙ operation hours).

The size of the largest configuration of a water electrolyser stack directly coupled to a solar photovoltaic array may be limited by different factors. One example may be a practical limitation for the voltage and current desired on the direct coupled DC electrical connection, which in one case may be, for example, up to 1500 V and up to 4000 A. Accordingly, the water electrolysis system has a size of from 10 kW, 50 kW, 100 kW, 1 MW up to 6 MW. In this example, the largest configuration would be defined as approximately 6 MW (meaning: up to 6 MW solar photovoltaic array, directly coupled to an electrolyser stack(s) of up to 6 MW). With future developments in DC electrical connection materials, however, the largest configuration size may be expected to exceed 6 MW.

The design of very large (20 kW to multi-GW scale) solar photovoltaic directly coupled electrolyser systems may be defined as requiring two or more repeat units of the largest configuration as described, or two or more repeat units which may be smaller than the largest configuration, as required to deliver the desired amount of hydrogen product. As an illustration, the size of a single repeat unit of such very large solar photovoltaic directly coupled electrolyser systems may be in the range of 10 kW to 6 MW scale.

The design of very large solar photovoltaic directly coupled electrolyser systems may be defined according to the spatial positioning of the PV arrays, electrolyser stacks, electrolyser balance of plant items and the auxiliary power supply. The layout of such very large systems may be optimized by such factors as the amount and distance of electrical cabling required, the amount and distance required to transport gaseous products in pipes (hydrogen and/or oxygen) and whether the electrolysers are present in multiple locations dispersed throughout the system, or in a centralized location.

In a preferred embodiment the electrolyzer stacks and balance-of-plant are co-located in a defined position and are surrounded by PV arrays (See FIG. 8). The electrolyser systems are decentrally located, and situated within, or as close as possible to the direct coupled photovoltaic arrays of the repeat unit. The optimization may be made to reduce the distance of electrical cabling required, resulting in a clustered design with each repeat unit of decentralized electrolysers (820) being placed as close as possible to the PV array in each cluster (800). The location of the auxiliary power supply is not shown in FIG. 8. In this particular configuration the hydrogen is produced at multiple locations and must be collected at some central location for utilization or transport, resulting in proportionally higher costs associated with pressure loss in transport of pressurized gases and the materials required for construction of pipes (840). The relative cost of gas transport pipes and electrical cabling may be optimized. In this design, each electrolyser system will contain a dedicated balance of plant, located in the cluster with the electrolyser stack.

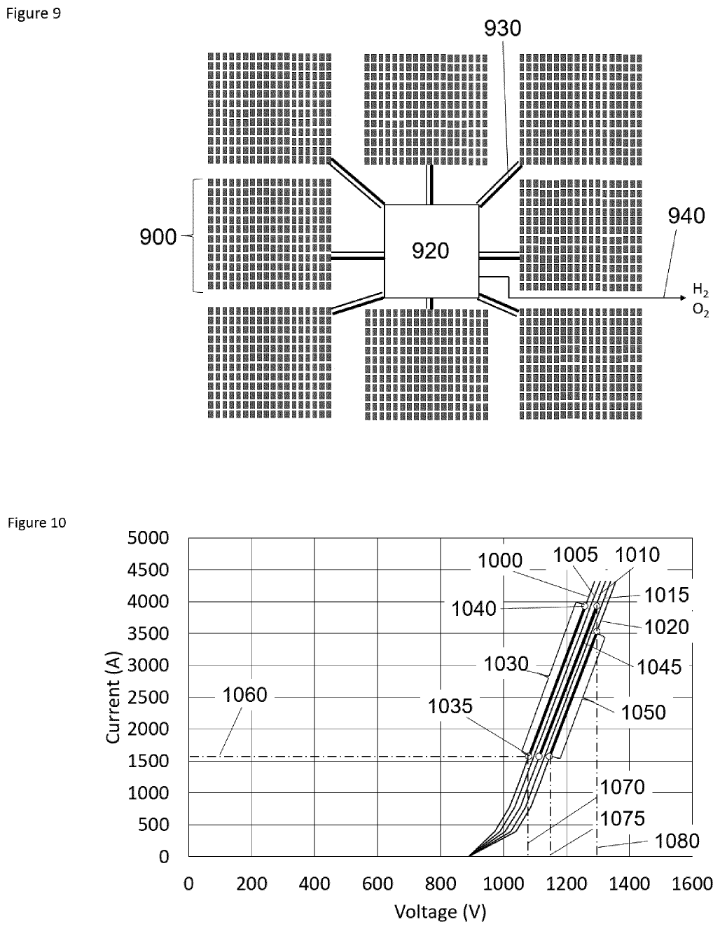

In another preferred embodiment, repeat units are arranged to co-locate the electrolyser stacks in a centralised location, preferably with a shared electrolyser balance of plant and system (See FIG. 9), surrounded by solar photovoltaic arrays which are directly connected to individual electrolyser stack(s) in the centralized electrolyser system. The location of the auxiliary power supply is not shown in FIG. 9. The optimization may be made to produce hydrogen at a central location, therefore reducing the distance of gas piping (940) required. Thus, preferably the electrolyzers (920) are co-located with the balance-of-plant and are located separate from, preferably in a central position, and in close proximity of the PV-arrays (900). In this particular configuration the power is transported from the solar photovoltaic arrays to a central electrolyser system location, resulting in proportionally higher costs associated with electrical wiring (930) and power loss during transport over increased distances. In this design the need for transport of hydrogen gas over long distances is minimized. The use of a centralized electrolyser system may also allow for cost reductions through optimization of balance of plant size and configuration, where multiple electrolyser stacks may be served by common balance of plant elements.

In another preferred embodiment, the optimization may be made to produce hydrogen in a reduced number of locations, therefore optimizing the balance of costs of electrical connections, hydrogen compression and piping, and the scaling of balance of plant elements with each cluster of electrolyser stacks. This embodiment represents a design combining elements of FIG. 8 and FIG. 9.

The following examples of certain aspects of some embodiments are given to facilitate a better understanding of the present invention. In no way should these examples be read to limit, or define, the scope of the invention.

### Examples

In one embodiment of the invention, the electrolyser arrangement is configured to match with a photovoltaic array power output. As described in the detailed description of this disclosure, performance curves of the photovoltaic array are calculated. Degradation rates of the photovoltaic modules are usually provided by the manufacturers as a percentage decrease of the power output with the age of the module. For example, a photovoltaic vendor can quote degradation rates in the range of 15% to 25%, for instance about 20% loss of power output in 20 years. In the example of 20% over 20 year, a degradation rate of about 1% per year is taken, and applied as a reduction in the short circuit current, L. Table 1 below shows an example of short-circuit current reduction with the aging of the photovoltaic array.

TABLE 1
Example of short-circuit current reduction
with ageing of the photovoltaic array.

| | | |
|---|---|---|
| I_{sc} | 9.69 | start of life |
| | 9.59 | 1 yr |
| | 9.50 | 2 yr |

The anticipated performance curve of the photovoltaic array for a specific timeline can be calculated by decreasing the short circuit current values based on the derived annual degradation rate at specific voltages. Specific timeline considered can be the end of life of the photovoltaic array or midlife of the photovoltaic array. The specific timeline considered can be any timeline between the start of life and an end of life of the photovoltaic array.

Next step is to configure the electrolyser arrangement that needs to be directly connected with the photovoltaic arrangement. Configuration involves deciding the number of electrolyser stacks that need to be included and the number of electrolyser cells that need to be included in each stack so that an optimized configuration of the electrolysis system at an increased efficiency and a safe operation of the system can be achieved.

The process involves matching the electrolyser arrangement to the photovoltaic array power outputs by selecting the number of electrolyser stacks in an electrolyser arrangement and the number of electrolyser cells that need to be arranged in each of the electrolyser stack.

The process of matching may include the following steps (referring to FIG. 6):
Configure the electrolyser arrangement in such a way that maximum operating point (665) of the electrolyser arrangement may be matched closely with the maximum power point (655) of the anticipated performance curve of the photovoltaic array. The degree of closeness of the matching may be based on a design limitation of the electrolyser arrangement. Each configuration of the electrolyser arrangement may have their own performance curve and therefore, their own maximum operating point and it is preferred to have a configuration that has got a maximum operating point near to the maximum power point (665) of the photovoltaic array.
The anticipated performance curve of the photovoltaic array that has been considered in the previous step should be the one that is taken into account the maximum expected irradiance at a specific location where the water electrolysis system is planned to be operated.
The electrolyser performance curve should be above the maximum photovoltaic output at high irradiance, therefore protecting against over power.
Maximum operating point (665) of the electrolyser arrangement mentioned in the first step can be based on the predetermined performance curve of the electrolyser arrangement or it can be based on an anticipated performance curve of the electrolyser arrangement based on an assumed or predicted degradation rate of the electrolyser arrangement.

In another embodiment of the invention, configuration of the electrolyser arrangement is defined first based on the desired total power or hydrogen production requirement, paying attention to practical limitations on the DC electrical connection, which may be <1500 V and approximately 4000 A. As described in the detailed description, performance curves of the electrolyser arrangement are calculated. A first approximation of electrolyser arrangement aging can be defined by gradual increases in cell resistances; ionic and electrical ohmic resistance and activation overpotentials. This can be quantified by a steady (averaged) degradation rate, applied to the linear portion of the electrolyser polarization curve. For example, a degradation rate of 7 μV/hour can be assumed. Based on this degradation rate, an anticipated performance curve of the electrolyser arrangement for a specific timeline is calculated by increasing the voltage output at specific current values as shown in FIG. 10. Specific timeline can be the predicted end of life of the electrolyser arrangement and it is expressed in terms of operation hours of the electrolyser arrangement. For example, approximate life of an electrolyser stack may be 80000 operation hours and the anticipated performance curve can be calculated by increasing the voltage values proportionately based on the degradation levels.

Next step is to configure the photovoltaic array that needs to be directly coupled with the electrolyser arrangement. Configuration involves deciding the number of photovoltaic modules in each string and the number of strings that need to be connected in parallel to make the photovoltaic array based on the matching of performance curves of the electrolyser arrangement and the photovoltaic array.

The process of matching may include the following steps:
Configure the photovoltaic array in such a way that maximum power point (655) of the anticipated performance curve of the photovoltaic array may be matched closely with the maximum operating point (665) of the electrolyser arrangement. The degree of closeness of the matching may be based on a design limitation of the photovoltaic array. Each configuration of the photovoltaic array may have their own performance curve and therefore, their own maximum power point and it is preferred a photovoltaic array configuration that has got a maximum power point (655) near to the maximum power point (665) of the electrolyser arrangement.
The anticipated performance curve of the photovoltaic array that has been considered in the previous step should be the one that has considered the maximum expected irradiance at a specific location where the water electrolysis system is planned to be operated. For instance, solar irradiation in Amsterdam would be typically be less than 1000 W/m², where in certain locations in Australia it would typically be less than 1250 W/m².
The electrolyser performance curve should be above the maximum photovoltaic output at high irradiance, therefore protecting against over power.
Maximum operating point (665) of the photovoltaic array mentioned in the first step can be based on the predetermined performance curve of the photovoltaic array or it can be based on an anticipated performance curve of the photovoltaic array based on an assumed or predicted degradation rate of the photovoltaic array

In the embodiments described, the direct coupled arrangement of the solar photovoltaic array and electrolyser stack arrangements require additional equipment to create a fully functional solar photovoltaic coupled water electrolyser system. The water electrolyser system contains an arrangement of electrolyser stacks, and supporting hardware required for efficient operation of the electrolyser stack, typically referred to as the balance of plant (BoP). The configuration of the BoP is designed to safely and efficiently operate the electrolyser stack arrangement. The configuration of the BoP may be optimized based on the size and configuration of the electrolyser stack arrangement, for example multiple electrolyser stacks may be supported by a single BoP.

An auxiliary power supply is required for the stable and safe operation of the BoP, which typically would include an AC electrical connection. The configuration of the auxiliary power supply may be specified based on the amount of time power must be guaranteed to the electrolyser system BoP. The auxiliary power supply may be specified to operate continuously without power outage. Further, the auxiliary power supply may be specified to supply power for a pre-determined duration, to allow for safe operation and shut down of the water electrolyser system.

The design of very large (20 kW to multi-GW scale) solar photovoltaic directly coupled electrolyser systems may be defined as requiring two or more repeat units of solar photovoltaic coupled water electrolysis configurations. Two or more distinct repeat units are selected as required to deliver the desired amount of hydrogen product. Examples of large scale configurations are shown in FIGS. 8 and 9.

1. A method of configuring a direct-coupled water electrolysis system comprising at least four components, wherein the first component is a PV-array which is directly connected to the second component which is an electrolyzer stack or multiple electrolyzer stacks, the third component is an electrolyzer system balance-of-plant, and the fourth component is an auxiliary power supply, the method comprising the steps of:
a) providing a predetermined initial performance curve of the PV array;
b) providing an average degradation rate of the PV array;
c) calculating an anticipated performance curve of the PV array for a specific timeline by modifying the predetermined initial performance curve based on the average degradation rate;
d) providing a predetermined initial performance curve of the electrolyzer stack or multiple electrolyzer stacks;
e) providing an average degradation rate of the electrolyzer stack or multiple electrolyzer stacks;
f) calculating an anticipated performance curve of the electrolyzer stack or multiple electrolyzer stacks for a specific timeline by modifying the predetermined initial performance curve based on the average degradation rate for each individual stack;
g) configuring the electrolyzer stack or multiple electrolyzer stacks by matching the anticipated electrolyzer stack or multiple electrolyzer stacks performance curve with the anticipated PV array performance curve.

2. The method of configuring a water electrolysis system of claim 1, wherein the specific timeline considered for calculating the anticipated performance curves in step c) and f), respectively, is any time between the start of life and end of life of the PV array and any time between the start of life and end of life of the electrolyzer stack or multiple electrolyzer stacks, respectively.

3. The method of claim 1, wherein the auxiliary power supply is configured to provide a stable power supply to the electrolyzer balance-of-plant.

4. The method of claim 3, wherein the auxiliary power supply comprises at least any one or more of the following: wind turbines, PV arrays, electrical grid connection, fuel cells and fuel storage or battery storage.

5. A method of configuring a large scale water electrolysis plant comprising two or more repeat units of electrolyser stacks direct coupled to solar photovoltaic arrays.

6. The method of claim 5, where the size of the repeat unit is in the range of 10 kW to 6 MW.

7. A water electrolysis system comprising at least four components, wherein
(1) the first component is a PV-array which is directly connected to
(2) the second component which is an electrolyzer stack or multiple electrolyzer stacks, so that there are no power conversion steps present in the direct coupled connection,
(3) the third component is an electrolyzer system balance-of-plant, comprising supporting hardware required for efficient operation of the electrolyser stack, computer control systems, safety systems and power supply, and
(4) the fourth component is an auxiliary power supply for the stable and safe operation of the third component.

8. The water electrolysis system according to claim 7, wherein the electrolyzer stack, or stacks, and balance-of-plant are co-located in a defined position and are surrounded by PV arrays.

9. The water electrolysis system according to claim 7, wherein the electrolyzer stack or stacks are co-located with the balance-of-plant, preferably in a centralized location, and are located separate from the PV-arrays.
